(19) United States
(12) Patent Application Publication
(10) Pub. No.: US 2008/0017690 A1
(43) Pub. Date: Jan. 24, 2008

(54) Sign stapler

(76) Inventor: Alexander Nikolaevich Galitsky, Altamonte Springs, FL (US)

Correspondence Address: Alexander N. Galitsky, 315 Lakepointe Dr. #103, Altamonte Springs, FL, 32701, US

(21) Appl. No.: 11/879,195

(22) Filed: Jul. 17, 2007

Related U.S. Application Data
(60) Provisional application No. 60/832,278, filed on Jul. 21, 2006.

(51) Int. Cl. B25C 5/00

(52) U.S. Cl. 227/154

(57) ABSTRACT

A tool for attaching advertising signs or similar sheet material high up on wooden surfaces, poles, comprising: a hammer-type stapler; an elongated handle where hammer-type stapler is fitted and secured by a safety pin; a fixation mechanism for temporarily holding sheet material, for instance an advertisement sign, long enough to deliver the first blow and attach the sign.

### RELATED APPLICATION

U.S. Pat. No. 6,550,660—Hammer-Type Stapler With Tab Feeder (Chlebowski, et al.)

### BACKGROUND OF THE INVENTION

The present invention relates to a fastening tool for attaching sheet material, for instance for attaching advertising signs on a wooden surface, poles. In particular, the invention is well suited for efficiently attaching advertising or political campaign signs high up on telephone poles.

A problem in attaching sheet materials, including advertisement signs, is that it is necessary to set and hold the sheet itself, connecting element (pin, nail, staple, glue, etc) and then, hit it with a hammer-type stapler.

Known Hammer Type Stapler With Tab Feeder (U.S. Pat. No. 6,550,660 Chlebowski, et al.) which is able to attach sheet material with one swing of that type of the stapler, containing staples or nails, and the mechanism for it's continuous feed.

With that said, the problem of setting and holding of the to-be-attached-sheet remains.

More than that, it is often desired to attach the sheets high enough for the best view, and also to prevent easy removal. Previously to accomplish this one would have to climb on a ladder, hold the sign in one hand and use the hammer type stapler, in the other hand, then while trying to balance on the ladder, deliver few blows to attach the sign.

### BRIEF SUMMARY OF THE INVENTION

The present invention addresses this need by creating a light-weight handle extension for the Hammer Type Stapler, which is long enough to attach a sheet material to a desired height.

In example of the actual implementation, handle may be telescopic, fixed length, or contain a set of connecting extenders.

For further improvement it is necessary to install on the handle extension a mechanism to hold the sheet material, taking in consideration its size and the method of attaching.

The fixation may be a spring or other rigid material, glued on or removable. The fixation mechanism may also be implemented in the way that will allow it to slide up and down along the extension handle for sheets of a various sizes, or to adjust the place of the attachment of the sheet.

The mechanism may contain number of fixation mechanisms.

### BRIEF DESCRIPTION OF THE SEVERAL VIEWS OF THE DRAWING

FIG. 1, is a perspective view of the Sign Stapler in accordance with the present invention.

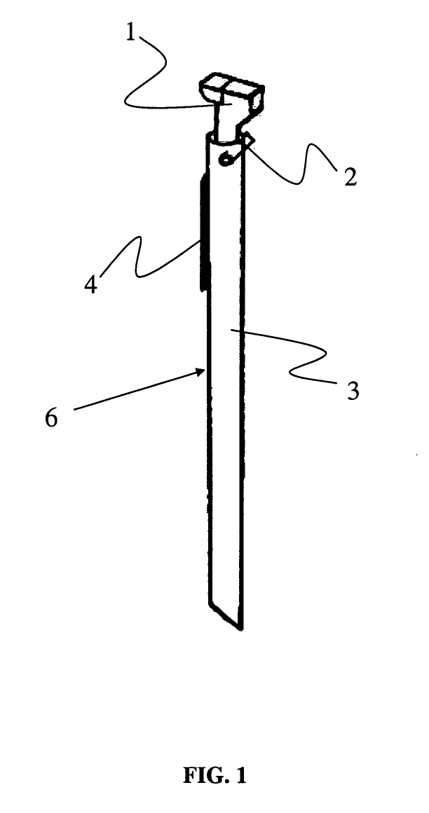

FIG. 2, is a perspective view of the Sign Stapler with a sheet material (advertising sign) loaded.

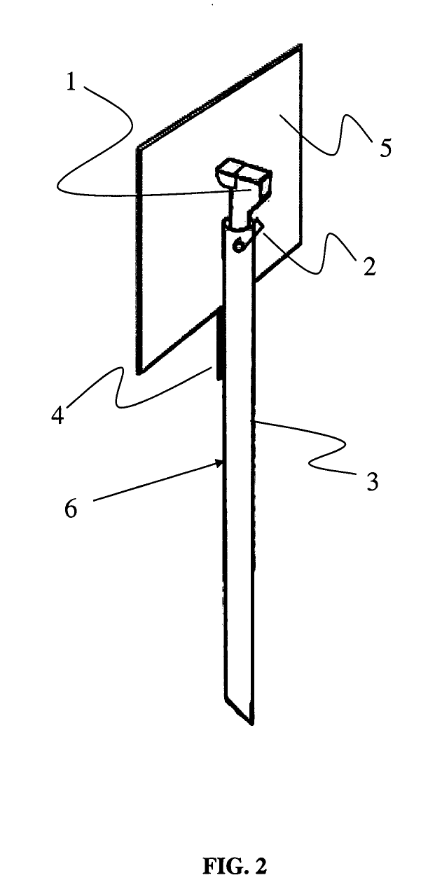

FIG. 3, is a perspective view of the Sign Stapler's mechanism which holds the sheet material in place.

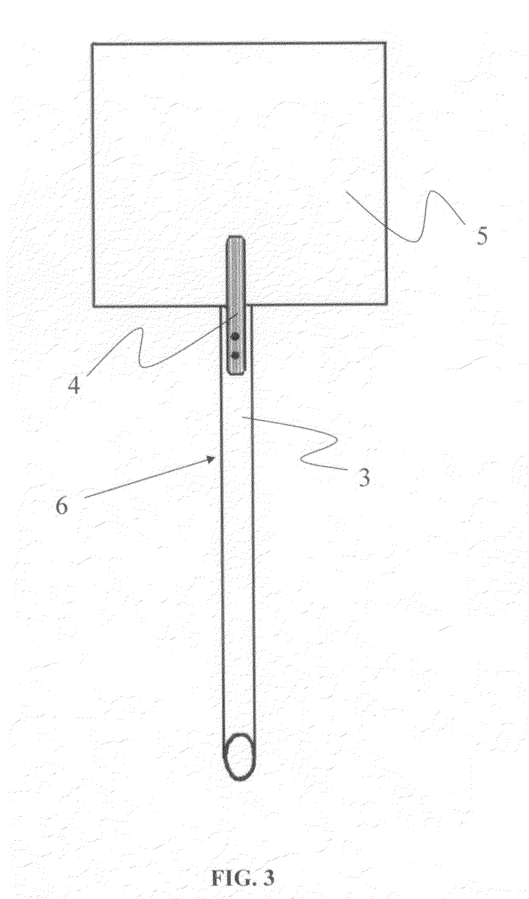

### DETAILED DESCRIPTION OF THE INVENTION

In the following description, like reference characters designate like or corresponding parts throughout the views.

Sign Stapler, generally 6, is comprised of a hammer-type stapler, generally 1, an elongated handle, generally 3, where hammer-type stapler 1 is fitted, and secured by a safety pin, generally 2, and also contains a fixation mechanism, generally 4, for holding sheet material for instance an advertisement sign, generally 5.

In operation, the user grasps the handle 3, with one hand, inserts a sheet material, or sign 5 with the other into the sign holder 4, then grasps the handle 3 with both hands, picks up the sign stapler 6 up in the air above the head and delivers a blow against a wooden material, for instance a pole, attaching the sign to it. When a staple penetrates the sign and goes into the wood, the momentum of the sign stapler 6 naturally moves it downward and the sign stapler slides down releasing the sign 5. At that point sign 5 is attached with one staple and sign stapler 6 is not loaded with a sign, which means the user then may choose to delivers few more blows with sign stapler 6, to secure the sign further.

1. Fastening tool for attaching sheet material to surface, including a hammer-type fastener with fastening elements(pin, nail, staple, glue etc.) and elongated handle, characterized in that it has additionally extended handle and clamp (clip) for temporal fixation of sheet and being set on extended handle on the distance fitting to sheet to be fastened.

2. Fastening tool as set force in claim 1, characterized in that the clamp for temporal fixation is movable with fixation along the handle for adjustment to the size of sheet to be fastened.
